(19) United States
(12) Patent Application Publication
(10) Pub. No.: US 2008/0049720 A1
(43) Pub. Date: Feb. 28, 2008

(54) System and method of delivering data via a network

(75) Inventors: Guangtian Liu, Cedar Park, TX (US); Weijing Chen, Austin, TX (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/510,855

(22) Filed: Aug. 25, 2006

(51) Int. Cl. H04L 12/66

(52) U.S. Cl. 370/352; 370/401

(57) ABSTRACT

A system and method for delivering data via an internet protocol television (IPTV) network are disclosed. In a method disclosed, a first data packet of a first data stream is received. The method determines whether a corresponding second data packet of a second data stream has been forwarded. The corresponding second data packet includes a second payload substantially the same as a first payload of the first data packet. When the corresponding second data packet has not been forwarded, the method forwards the first data packet.

### FIELD OF THE DISCLOSURE

The present disclosure is generally related to computer networks and more particularly to delivering data via networks.

### BACKGROUND

In a data delivery network, content is typically sent from a source to a destination. For example, in an internet protocol television (IPTV) network, video content is delivered via IP multicast from the source, usually a super hub office, to set-top boxes in viewers' homes. To improve reliability, redundant sources may be used. In such systems, in case of source failure or isolation, the data delivery network can switch to a backup source to continue to provide services. However, these systems often require more time to switch to backup sources than is desirable. Additionally, such systems typically only guard against a single failure scenario, resulting in service interruptions if multiple failures occur. Hence, there is a need for an improved system and method of delivering data via networks.

### BRIEF DESCRIPTION OF THE DRAWINGS

FIG. 1 is a block diagram of a particular illustrative embodiment of a system to deliver data via a network;

FIG. 2 is a block diagram of a second particular illustrative embodiment of a system to deliver data via a network;

FIG. 3 is a flow diagram of a particular illustrative embodiment of a method of delivering data via a network;

FIG. 4 is a flow diagram of a second illustrative embodiment of a method of delivering data via a network;

FIG. 5 is a data flow diagram of a particular illustrative embodiment of a system for delivering data via a network;

FIG. 6 is a flow diagram of a third particular illustrative embodiment of a method of delivering data via a network;

FIG. 7 is a flow diagram of a fourth particular illustrative embodiment of a method of delivering data via a network;

FIG. 8 is a flow diagram of a fifth particular illustrative embodiment of a method of delivering data via a network; and

FIG. 9 is an illustrative embodiment of a general computer system.

### DETAILED DESCRIPTION OF THE DRAWINGS

The present disclosure includes systems, methods, and computer readable media for delivering data via a network.

An exemplary embodiment of a device for delivering data via a network includes a first input to receive a plurality of first data packets of a first data stream. Each first data packet includes a first packet sequence identifier. The device also includes a second input to receive a plurality of second data packets of a second data stream. Each second data packet includes a second packet sequence identifier, corresponding to the first packet sequence identifier of one of the plurality of first data packets. The device also includes an output to send a third data stream. The third data stream includes selected data packets of the plurality of first data packets and the plurality of second data packets. The device also includes logic to select data packets of the third data stream. The selected data packets include data packets with packet sequence identifiers that have not previously been sent by the output.

An exemplary embodiment of a method of delivering data a network includes receiving a first data packet of a first data stream. The method also includes determining whether a corresponding second data packet of a second data stream has been forwarded. The corresponding second data packet includes a second payload substantially the same as a first payload of the first data packet. The method also includes forwarding the first data packet when the corresponding second data packet has not been forwarded.

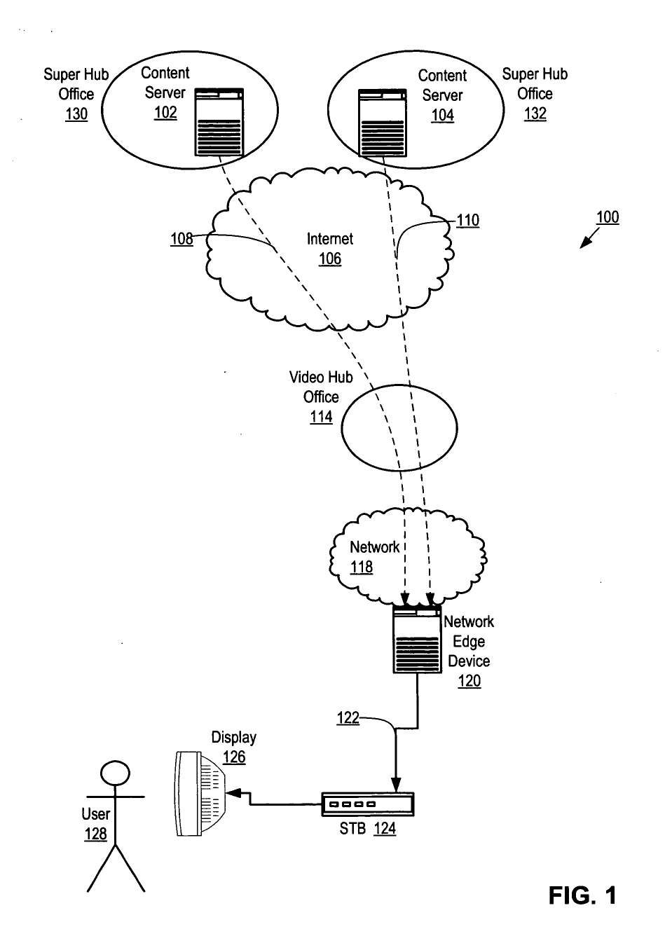

Referring to FIG. 1, a particular embodiment of a system 100 to deliver data via a network is depicted. The system 100 includes a first source, such as the first content server 102 at super hub office 130; a second source, such as the second content server 104 at super hub office 132; a network edge device 120; and one or more user devices, such as set-top box (STB) 124 and display 126. The content servers 102 and 104 communicate with the network edge device 120 through one or more public networks, such as the Internet 106; one or more private networks, such as private access network 118; and one or more hub offices, such as video hub office 114.

In an illustrative embodiment, the content servers 102 and 104 can be internet protocol television (IPTV) multicast servers. The first content server 102 sends a first IPTV multicast data stream 108, and the second content server 104 independently sends a second IPTV multicast data stream 110. The data streams 108 and 110 are redundant data streams, and are substantially synchronized when sent by the content servers 102 and 104. In a particular embodiment, the data streams 108 and 110 travel independent communication paths to the network edge device 120. For example, the communication paths of the data streams 108 and 110 may include no common components with respect to the Internet 106, the video hub office 114, the local network 118, or any combination thereof.

If no failure occurs during communication of the data streams 108 and 110, the network edge device 120 receives both of the data streams 108 and 110. However, since the data streams have traveled different communication paths, the data streams may not be synchronized. For example, one or more data packets from the first data stream 108 may arrive before or after a corresponding data packet of the second data stream 110. The network edge device 120 prepares a third data stream 122 to communicate to a user device, such as the set-top box (STB) 124. The third data stream 122 can be used, for example, to create a display on a display device 126 for viewing by a user 128.

In a particular illustrative embodiment, the network edge device 120 can prepare the third data stream 122 by receiving a first data packet, such as a data packet of the first data stream 108. The network edge device 120 determines whether a corresponding data packet of the second data stream 110 was previously sent to the STB 124. For example, since the data streams 108 and 110 are redundant, the first data packet can include a payload that corresponds to the payload of a data packet of the second data stream 110. The network edge device 120 may determine whether a data packet including the payload of the received first data packet was forwarded in the third data stream 122. If a data packet including the payload of the received first data packet was not previously forwarded, the received first data packet can be forwarded. Thus, in a particular embodiment, the third data stream 122 can include whichever of a pair of corresponding data packets arrives at the network edge device first. It is understood that more than two data sources may be used, so that network edge device receives more than two data streams. In such an embodiment, the data stream created by network edge device 120 may include whichever of the three or more corresponding data packets arrives at the network edge device first.

In a particular embodiment, the STB 124 receives the third data stream 122. The STB 124 sends a signal to display 126 based on the third data stream 122 to form a display of video content on display 126.

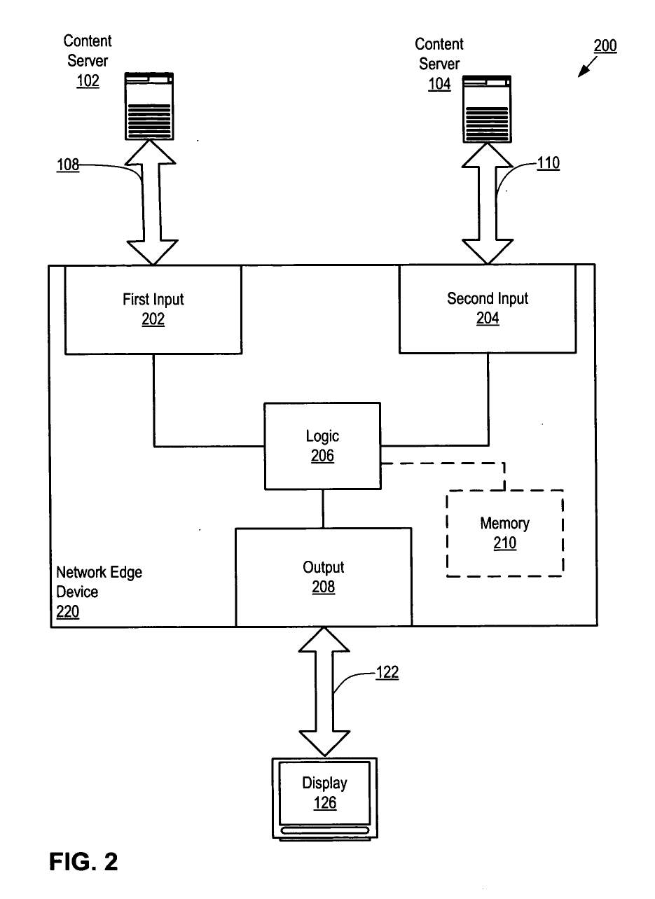

FIG. 2 is a block diagram of a second particular embodiment of a system to deliver data via a network. The system 200 includes a first content server 102, a second content server 104, a network edge device 220, and one or more user devices, such as display 126. The content servers 102 and 104 send data streams 108 and 110 to the network edge device 220. The network edge device 220 sends a third data stream 122 to one or more user devices, for example to form a display screen or video image on display 126.

The network edge device 220 includes a first input 202 to receive a plurality of first data packets of a first data stream 108 from the first content server 102. The network edge device 220 also includes a second input 204 to receive a plurality of second data packets of a second data stream 110 from the second content server 104. The first and second data streams 108 and 110 include corresponding data packets. For example, each first data packet of the first data stream 108 and each second data packet of the second data stream 110 can include a packet sequence identifier, where each second data packet includes a packet sequence identifier corresponding to a packet sequence identifier of one of the plurality of first data packets.

In a particular illustrative embodiment, the first data stream 108 and the second data stream 110 can be redundant internet protocol television (IPTV) data streams. That is, the first data stream 108 and the second data stream 110 can include data packets of identical video content, and can be substantially synchronized when sent from the content servers 102 and 104.

In a particular illustrative embodiment, the system 200 can be configured to provide high availability communications. For example, the first content server 102 can be located at a first super hub office, and the second content server 104 can be located at a second super hub office. The network edge device 220 can be a digital subscriber line multiplexer (DSLAM). The first data stream 108 and the second data stream 110 can be sent via different communications channels to the network edge device 220, such that the network edge device 220 is the first point at which there is a single point of failure for the first and second data streams.

The network edge device 220 also includes logic 206 to select data packets to include in the third data stream 122. Data packets selected to include in the third data stream 122 by logic 206 include data packets with packet sequence identifiers that have not previously been sent by the output 208. The network edge device 220 also includes an output 208 to send a third data stream 122 to display 126. The third data stream 122 can include selected data packets of the plurality of first data packets and the plurality of second data packets.

The network edge device 220 also includes a memory 210 accessible by the logic 206. The memory 210 stores a record of sent data packets. In an illustrative embodiment, the memory 210 does not store the contents of the data packets that have already been sent. In a particular embodiment, the memory 210 does not store multiple data packets to sort or order them, or to check for continuity of a data stream.

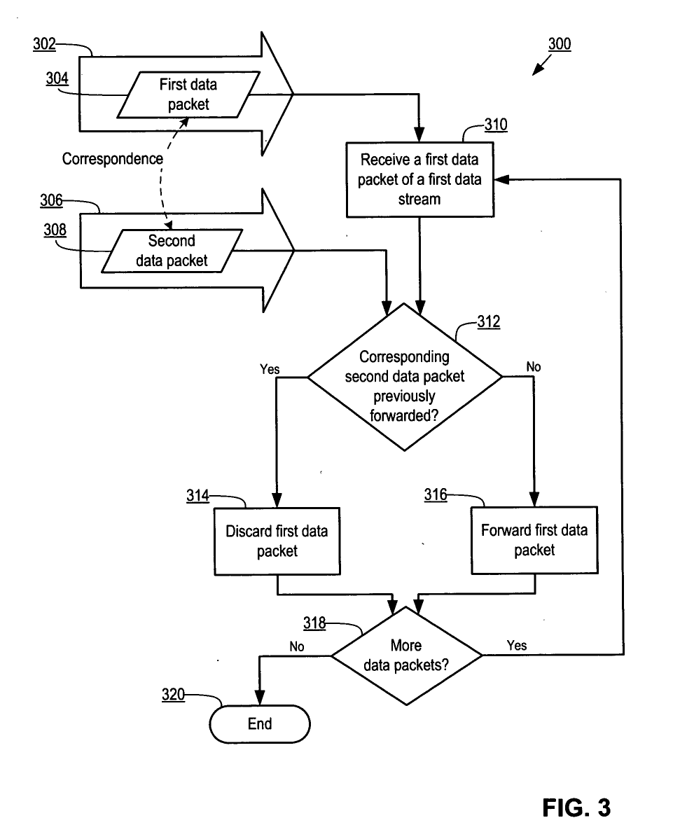

FIG. 3 is a flow chart of a particular illustrative embodiment of a method 300 of delivering data via a network. In the method 300 a first data stream 302 including a first data packet 304 and a second data stream 306 including a second data packet 308 are received. The first data packet 304 and the second data packet 308 correspond to one another. For example, the first data packet 304 and the second data packet 308 can include substantially similar contents. In a particular illustrative embodiment, the first data packet 304 and the second data packet 308 include identical contents.

The method 300 includes receiving 310 a first data packet 304 of the first data stream 302. The method 300 also includes determining 312 whether a corresponding second data packet 308 of the second data stream 306 was previously forwarded. If the corresponding second data packet 308 was not previously forwarded, the method 300 includes forwarding 316 the first data packet 304. If the corresponding second data packet 308 was previously forwarded, the method 300 includes discarding 314 the first data packet 304. The method also includes determining 318 whether more data packets are to be received. If more data packets are to be received, the method returns to receive 310 first data packets. If no more data packets are to be received, the method terminates 320.

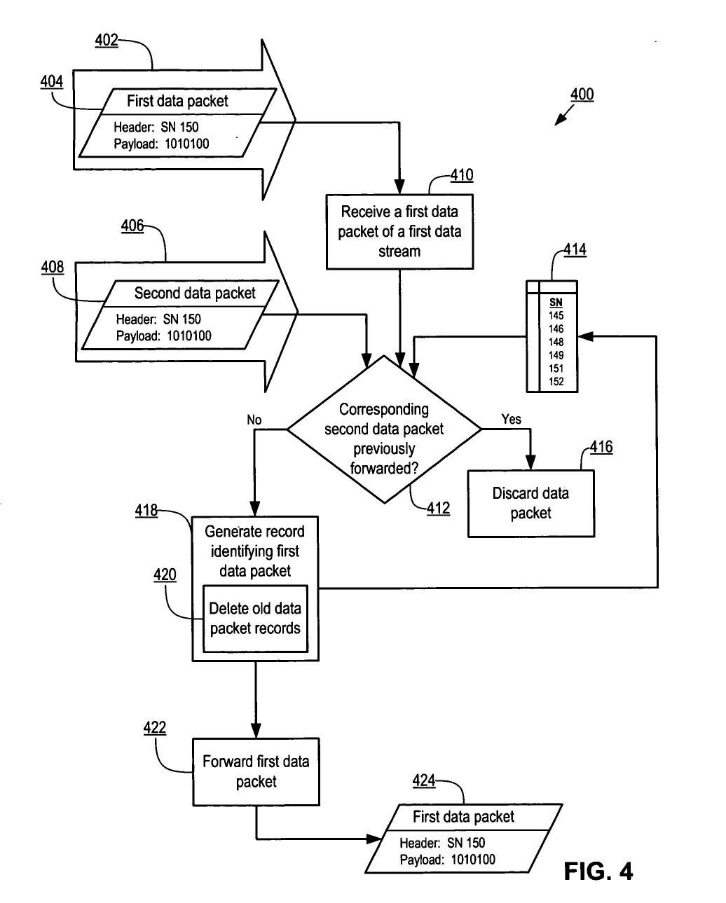

FIG. 4 is a flow chart of a second illustrative embodiment of a method 400 of delivering data via a network. In the method 400 a first data stream 402 including a first data packet 404 and a second data stream 406 including a second data packet 408 have been sent.

In a particular illustrative embodiment, the first and second data streams 402 and 406 may be IPTV multicast data streams. In such an embodiment, the data packets may include a payload, such as IPTV content, and a header which contains metadata about the payload or data packet. The data packet header may include a packet sequence identifier that identifies where the payload falls within a sequence of data packets making up the data stream. For example, a sequence number (SN) is such a packet sequence identifier. Multicast IPTV data streams may include multiple channels of content. In that case, the data packet header may also include information about which channel the data packet includes data from, such as a stream identification number (SID). Corresponding data packets of the first and second data streams 402, 406 may have the same SN and SID

As shown in FIG. 4, the first data packet 404 and the second data packet 408 may each include a header and a payload. The header of the first data packet 404 identifies the sequence number (SN) of the first data packet as SN 150. Likewise, the header of the corresponding second data packet 408 identifies the SN of the second data packet as SN 150. The first and second data packets 404 and 408 also include identical payloads.

In the FIG. 4, only the first data packet 404 and the second data packet 408, which correspond to one another, are depicted. Both the first data stream 402 and the second data stream 406 may include many data packets. Under normal operating conditions, each data packet of the first data stream 402 may have a corresponding data packet in the second data stream 406. However, due to certain circumstances, such as equipment failures, software problems, and so forth, the not every data packet of the first data stream 402 and the second data stream 406 may have a corresponding data packet in the other stream.

The method 400 includes receiving 410 a first data packet 404 of the first data stream 402. The method 400 also includes determining 412 whether a corresponding second data packet 408 of the second data stream 406 was previously forwarded. In a particular illustrative embodiment, a record 414 of forwarded data packets may be maintained. In such an embodiment, the record 414 of forwarded data packets may be accessed to determine whether the corresponding second data packet was previously forwarded. The record 414 of forwarded data packets may include a record of a packet sequence identifier of each forwarded data packet. In a particular illustrative embodiment, the record 414 of forwarded data packets may include a record of groups of forwarded data packets.

In a particular embodiment, the first and second data streams 402 and 406 are not buffered before the first data packet is forwarded. For example, the method 400 may not collect a plurality of data packets from either the first or the second data stream 402 and 406 before forwarding a received data packet that has not previously been forwarded. In an illustrative embodiment, the record 414 of forwarded data packets does not include the contents of forwarded data packets or of data packets to be forwarded, rather the record 414 of forwarded data packets includes identifying information for forwarded data packets.

If the corresponding second data packet 408 was previously forwarded, the method 400 includes discarding 416 the first data packet 404. If the corresponding second data packet 408 was not previously forwarded, the method 400 includes generating 418 a record identifying the first data packet 404. The generated record may be stored in the record 414 of forwarded data packets. The method 400 may also include deleting 420 old data packet records. That is, only a certain number of the most recently received or most recently forwarded data packets may be maintained in the record 414 of forwarded data packets.

The method 400 also includes forwarding 422 the first data packet 424. In this context, forwarding 422 the first data packet 424 refers to sending a data packet including at least the payload of the first data packet and appropriate information to allow a downstream user to be able to utilize the data packet. In a particular embodiment, for example, forwarding the first data packet may include sending the payload of the first data packet and header information such as, the packet sequence identifier, and SID. In another particular embodiment, forwarding the first data packet may include encapsulating the first data packet with a new header and sending the data packet.

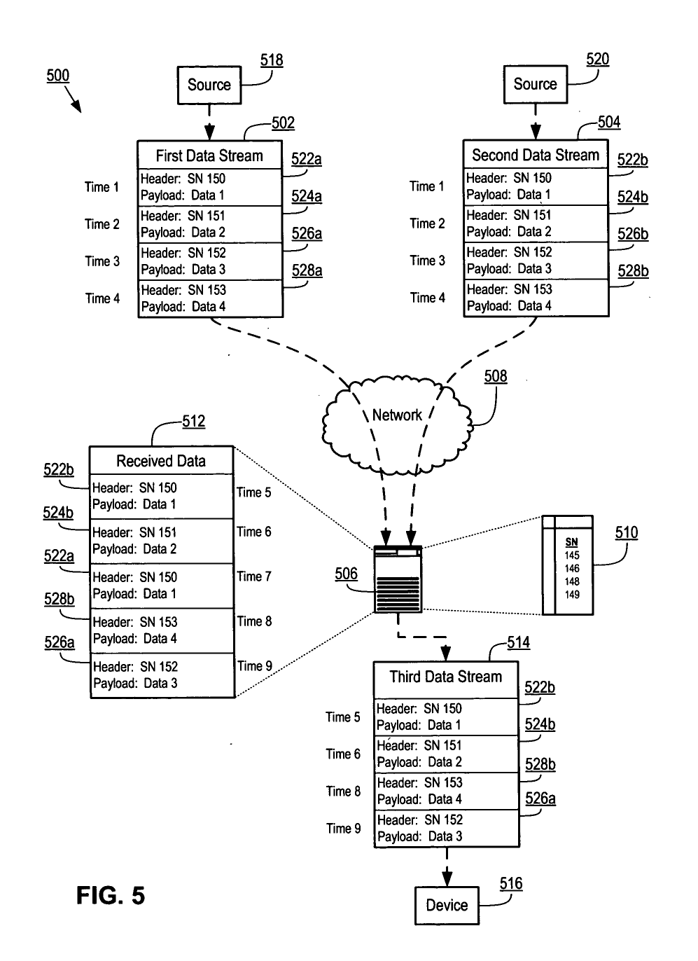

FIG. 5 is a data flow diagram of a system 500 to deliver data via a network. The system 500 includes a first data stream 502 and a second data stream 504. In a particular embodiment, the first data stream 502 originates from a first source 518, such as a first super hub office, and the second data stream 504 originates from a second source 520, such as a second super hub office. In an illustrative embodiment, the first data stream 502 and second data stream 504 are redundant IPTV multicast data streams. The first and second data streams 502 and 504 are used to create a third data stream 514. The third data stream 514 is a merged data stream. For example, the third data stream 514 can include data packets from the first data stream 502 intermixed with data packets from the second data stream 504.

The system 500 also includes a network 508. In a particular illustrative embodiment, the network 508 may include a global network, such as the Internet; a local network, such as a private access network of an IPTV service provider; or other network. The network 508 can include multiple communication paths such that the first and second data streams 502 and 504 do not share at least a portion of their respective communication paths. In one embodiment, a network edge device 506 is the first common element in the communication paths from the first and second sources 518, 520 to a downstream device 516.

In a particular embodiment, the first and second data streams 502 and 504 can be substantially synchronized when sent from the first and second sources 518 and 520. For example, at time 1, the first source 518 sends a data packet 522a having a packet sequence identifier (SN) of SN 150 and payload of Data 1. Likewise, at time 1, the second source 520 can send a data packet 522b having a packet sequence identifier of SN 150 and payload of Data 1. Similarly, the first source 518 sends data packets 524a, 526a and 528a at times 2, 3 and 4, respectively, and the second source 520 sends the corresponding data packets 524b, 526b, and 528b at the same times.

As a result of differential communication delays, different routing, hardware or software problems, and other factors, corresponding data packets may arrive at the network edge device 506 at different times. Thus, for example, the received data 512 may include data packet 522b at time 5 and corresponding data packet 522a at time 7. Further, data packet 528b can be received before previously sent data packet 526a.

In an illustrative embodiment, the device 506 can include a record 510 of previously forwarded data packets. For simplicity of discussion, in FIG. 5 none of the data packets shown in the received data 512 are listed in the record 510 of previously forwarded data packets. In an embodiment, if a received data packet corresponds to a previously forwarded data packet, the received data packet is discarded.

The first to arrive of two or more corresponding data packets can be forwarded. For example, the device 506 can forward a data packet as it is received if a corresponding data packet has not been previously forwarded. For example, at time 5, data packet 522b is received by the device 506. Data packet 522a, which corresponds to data packet 522b, has not yet been received or forwarded. Since data packet 522a has not previously been forwarded based on the record 510 of previously forwarded data packet, the device 506 forwards data packet 522b at or about time 5, as shown in the third data stream 514. In a particular embodiment, the device 506 can update the record 510 of forwarded data packets to indicate that data packet 522b was forwarded. In an illustrative, non-limiting embodiment, the device 506 updates the record 510 of forwarded data packets by including the packet sequence identifier (SN) of data packet 522b in the record 510 of forwarded data packets.

In another example, at time 6, the device 506 receives data packet 524b. Corresponding data packet 524a has not been previously forwarded, so the device 506 forwards data packet 524b in the third data stream 514 at or about time 6 and updates the record 510 of forwarded data packets. At time 7, the device 506 receives data packet 522a. Corresponding data packet 522b was previously forwarded at time 5 and the record 510 of forwarded data packets was updated to show that data packet 522b was forwarded, so the device 506 discards data packet 522a. At time 8, the device 506 receives data packet 528b. Corresponding data packet 528a has not been previously forwarded, so the device 506 forwards data packet 528b in the third data stream 514 at or about time 8 and updates the record 510 of forwarded data packets. At time 9, the device 506 receives data packet 526a. Corresponding data packet 526b has not previously been forwarded, so the device 506 forwards data packet 526a at or about time 9 and updates the record 510 of forwarded data packets.

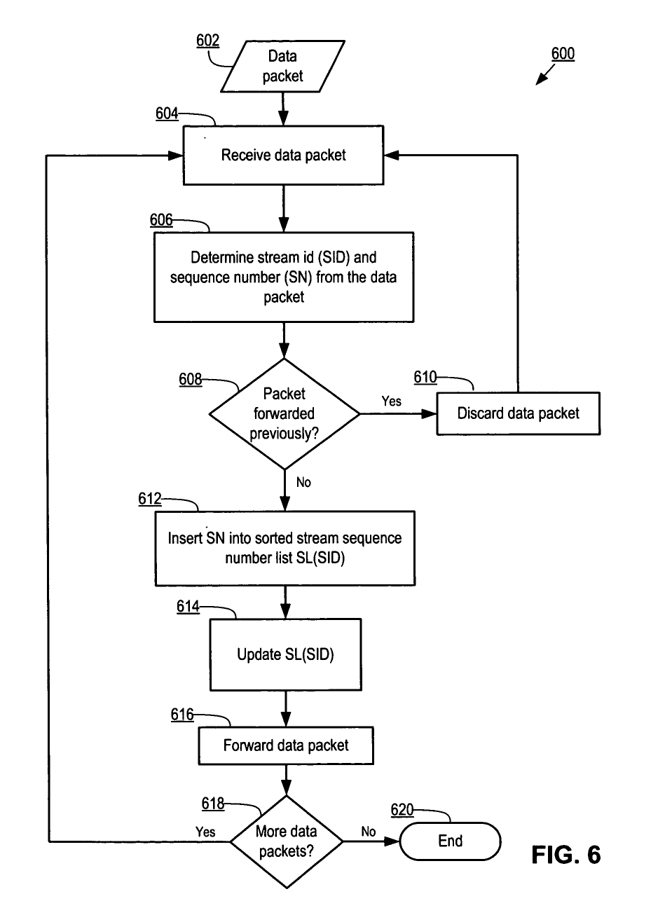

FIG. 6 is a flow diagram of a third embodiment of a method 600 of delivering data via a network. The method 600 includes receiving 604 a data packet 602, and determining 606 a stream id (SID) and sequence number (SN) of the data packet. As previously discussed, the SID is an identifier of a channel in a multicast IPTV data stream. The SN is a packet sequence identifier to identify the position of the data packet within a sequence of data packets that makes up a data stream.

The method 600 also includes determining 608 whether a corresponding data packet was forwarded previously. If a corresponding data packet was previously forwarded, the data packet 602 may be discarded 610. If no corresponding data packet has been forwarded, the method includes inserting 612 the SN of the data packet into a record of forwarded data packets. In the particular illustrative embodiment depicted, the record of forwarded data packets is a sorted list of sequence numbers for each SID, SL(SID). The method also includes updating 614 the SL(SID), and forwarding 616 the data packet.

In a particular embodiment, the method also includes determining 618 whether more data packets are to be received. If more data packets are to be received, the method returns to receive 604 data packets. If no more data packets are to be received, the method terminates 620.

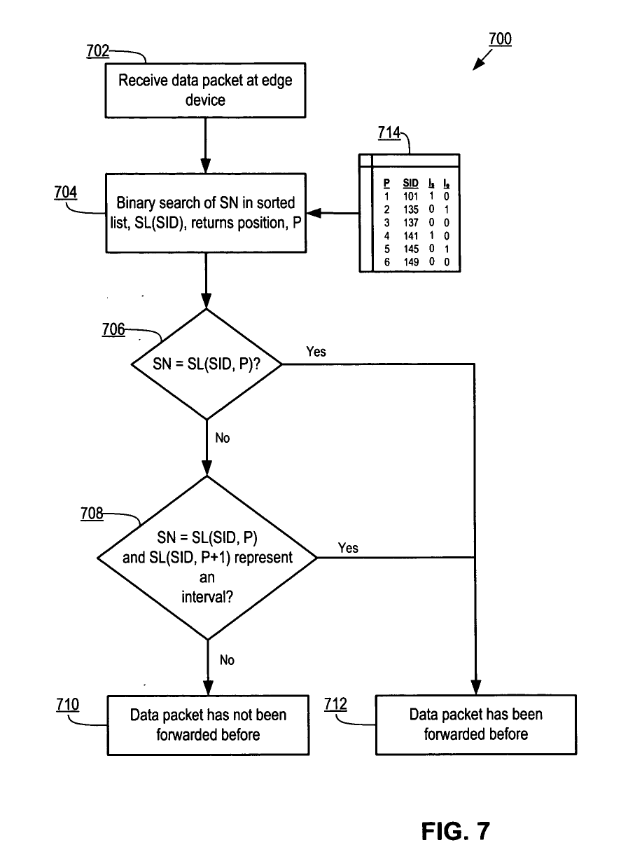

FIG. 7 depicts a flow diagram of a fourth particular embodiment of a method 700 of delivering data via a network. The method includes receiving 702 a data packet. The method 700 also includes conducting a binary search 704 of a SL(SID) 714 for the SN of a received data packet 702.

The method 700 accesses a record of forwarded data packets, (SL(SID)) 714. The SL(SID) 714 includes a number of positions, P. The SL(SID) 714 also includes a listing of sequence numbers (SN) of forwarded data packets in column SID. The SL(SID) 714 also includes interval flags to indicate whether the listed SN is the beginning of an interval, Is, or the end of an interval, Ie. By using the interval flags, a large range of sequence numbers can be identified by only two sequence numbers. For example, SN=101 appears at position P=1. The start interval flag associated with position P=1 is set to 1 indicating that SN=101 is the beginning of an interval. Also, SN=135 appears at position P=2. The end interval flag associated with position P=2 is set to 1 indicating that SN=135 is the end of an interval. Thus, positions P=1 and P=2 form an interval indicating that data packets having sequence numbers 101 through 135 have been forwarded.

In a particular embodiment, the binary search 704 returns a position, P, within the SL(SID) 714 where the SN would fall. For example, if the SN is 135 the binary search would return P=2 because SN=135 is located at position 2. If the SN were 136, the binary search would return P=3, because SN=136 should follow SN=135 and SN=135 is at position 2.

The method also includes determining whether the SN of the received data packet 702 is the value at position P of the SL(SID) 714 at decision block 706. Thus, using the example of SN=135, the binary search for SN=135 returns P=2. SN=135 is the value at position 2, so the method follows the “Yes” path from decision block 706 to a determination that the data packet 702 has already been forwarded at block 712. Other actions may be taken based on the determination that the data packet 702 has already been forwarded. For example, the data packet 702 may be discarded.

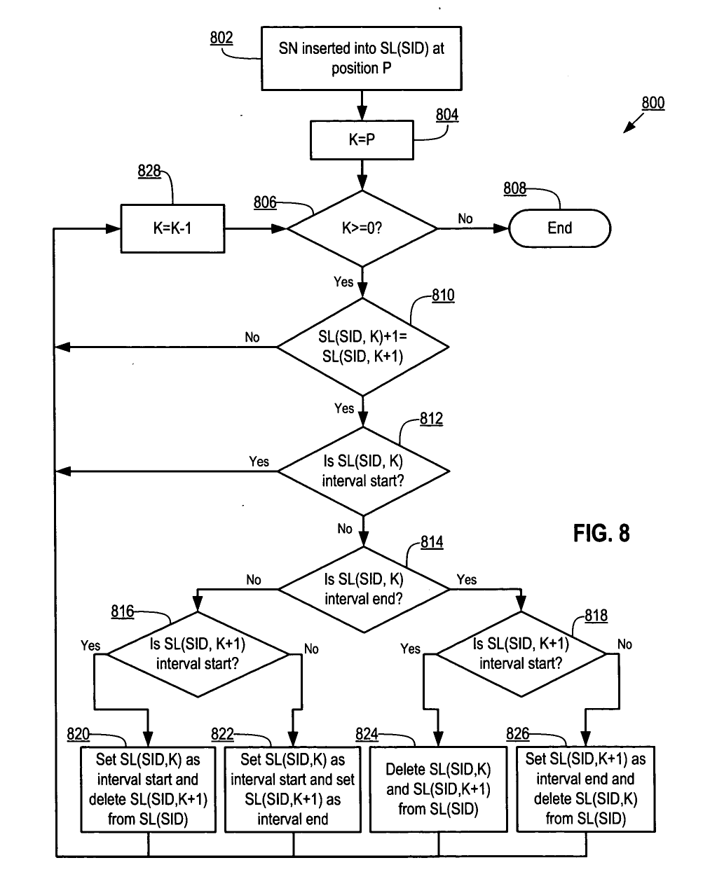

If the value at position P is not the same as the SN of the received data packet 702, the method proceeds to decision block 708. Decision block 708 determines whether the value at position P and the value at position P+1 of the SL(SID) 714 represent an interval. If positions P and P+1 form an interval, then the data packet has already been forwarded, and the method 700 follows the “Yes” path from decision block 708 to a determination that the data packet has been forwarded before. If positions P and P+1 do not form an interval, then the data packet has not been forwarded, and the method 700 follows the “No” path from decision block 708 to a determination that the data packet has not been forwarded before. Other actions may be taken based on the determination that the data packet 702 has not been forwarded. For example, the method depicted in FIG. 8 may be implemented to update the record of forwarded data packets and the data packet may be forwarded.

FIG. 8 depicts a flow diagram of a fifth particular embodiment of a method 800 of delivering data via a network. The method 800 includes inserting 802 the packet sequence identifier, SN, of a received data packet into SL(SID) at position P identified by the binary search described with reference to FIG. 7. The method 800 also includes setting 804 a counter, K, to P, the numeric value of position P.

The method 800 also includes determining whether K is greater than or equal to zero at decision block 806. If K is not greater than or equal to zero, then the method ends at terminal block 808. If K is greater than or equal to zero, the method 800 continues to decision block 810.

At decision block 810, the method 800 determines whether one plus the value at position K, SL(SID, K)+1, is equal to the value stored at position K+1, SL(SID,K+1). If SL(SID, K)+1 is not equal to SL(SID,K+1) then the method decrements K 828. If SL(SID, K)+1 is equal to SL(SID,K+1) then the method proceeds to decision block 812.

At decision block 812, the method 800 includes determining whether the value at position K, SL(SID,K), is the start of an interval. If SL(SID, K) is the start of an interval, the method decrements K 828. If SL(SID, K) is not the start of an interval, the method proceeds to decision block 814.

At decision block 814, the method 800 includes determining whether SL(SID, K) is the end of an interval. If SL(SID, K) is not the end of an interval, the method proceeds to decision block 816. If SL(SID, K) is the end of an interval, the method proceeds to decision block 818.

At decision block 816, the method 800 includes determining whether the value at position K+1, SL(SID, K+1), is an interval start. If SL(SID,K+1) is the start of an interval, the method sets 820 SL(SID, K) as the start of an interval and deletes SL(SID, K+1) from the SL(SID). If SL(SID,K+1) is not the start of an interval, the method sets 822 SL(SID, K) as the start of an interval and sets SL(SID, K+1) as the end of an interval.

At decision block 818, the method 800 includes determining whether SL(SID, K+1) is an interval start. If SL(SID,K+1) is the start of an interval, the method deletes 824 SL(SID, K) and SL(SID, K+1) from the SL(SID). If SL(SID, K+1) is not the start of an interval, the method sets 826 SL(SID, K+1) as the end of an interval and deletes SL(SID, K) from the SL(SID).

The method 800 then decrements K 828, and returns to decision block 806 to determine whether K is still greater than or equal to zero. If K is greater than or equal to zero the update process is repeated to update the remaining portions of the SL(SID). If K is not greater than or equal to zero, the method 800 ends at terminal block 808.

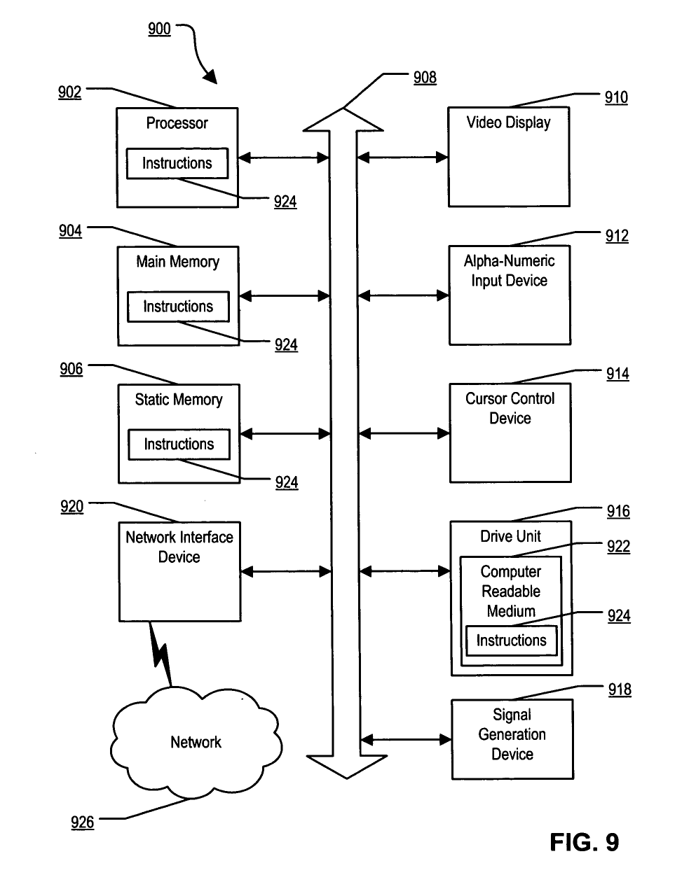

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900 may operate as a standalone device or may be connected, e.g., using a network, to other computer systems or peripheral devices, including a network edge device, such as that shown in FIGS. 1, 2 and 5.

In a networked deployment, the computer system may operate in the capacity of a serve, an edge device, or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. Moreover, the computer system 900 can include a main memory 904 and a static memory 906, that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. Additionally, although the present specification generally describes two data streams using IPTV protocols, it should be understood that more than two data streams may be used. Also, the methods and systems disclosed need not be limited to IPTV applications.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of delivering data via a network, the method comprising:
receiving a first data packet of a first data stream;
determining whether a corresponding second data packet of a second data stream has been forwarded, the corresponding second data packet including a second payload substantially the same as a first payload of the first data packet; and
forwarding the first data packet when the corresponding second data packet has not been forwarded.

2. The method of claim 1, wherein the first data stream and the second data stream comprise redundant IPTV video data streams.

3. The method of claim 2, wherein the first and second data streams comprise synchronized multicast IPTV video data streams.

4. The method of claim 2, wherein the first data stream is sent from a first super hub office of the IPTV network and the second data stream is sent from a second super hub office of the IPTV network.

5. The method of claim 4, wherein the first and second data streams are substantially synchronized when sent from the first and second super hub offices.

6. The method of claim 1, further comprising discarding the first data packet when the corresponding second data packet has been forwarded.

7. The method of claim 1, wherein:
the first data packet includes a packet sequence identifier to identify a position of the first data packet within the first data stream;
the corresponding second data packet includes the packet sequence identifier to identify a position of the corresponding second data packet within the second data stream; and
determining whether the corresponding second data packet has been forwarded includes determining whether a data packet having the packet sequence identifier has been forwarded.

8. The method of claim 1, further comprising generating a record indicating that the first data packet has been sent.

9. The method of claim 1, wherein the second payload of the corresponding second data packet is identical to the first payload of the first data packet.

10. The method of claim 1, wherein the first and second data streams are not buffered before the first data packet is forwarded.

11. The method of claim 1, further comprising maintaining a record of forwarded data packets.

12. The method of claim 11, wherein the record of forwarded data packets includes a packet sequence identifier of each forwarded data packet.

13. The method of claim 1 wherein the record of forwarded data packets includes groups of forwarded data packets.

14. A device, comprising:
a first input to receive a plurality of first data packets of a first data stream, each first data packet including a first packet sequence identifier;
a second input to receive a plurality of second data packets of a second data stream, each second data packet including a second packet sequence identifier corresponding to the first packet sequence identifier of one of the plurality of first data packets;
an output to send a third data stream, wherein the third data stream includes selected data packets of the plurality of first data packets and the plurality of second data packets; and
logic to select data packets of the third data stream, the selected data packets including data packets with packet sequence identifiers that have not previously been sent by the output.

15. The device of claim 14, wherein the device is a network edge device.

16. The device of claim 14, wherein the device comprises a digital subscriber line access multiplexer (DSLAM).

17. The device of claim 14, wherein the first data stream and the second data stream comprise redundant internet protocol television (IPTV) data streams.

18. The device of claim 14, further comprising a memory accessible by the logic, wherein the memory stores a record of sent data packets.

19. A computer readable medium tangibly embodying a program of instructions to manipulate a computing system to:
receiving a first data packet of a first data stream;
determining whether a corresponding second data packet of a second data stream has been forwarded, the corresponding second data packet including a second payload substantially the same as a first payload of the first data packet; and
forwarding the first data packet when the corresponding second data packet has not been forwarded.

20. The computer readable medium of claim 19, wherein the first and second data streams comprise synchronized multicast IPTV video data streams.

21. The computer readable medium of claim 19, wherein the program of instructions further manipulate a computing system to maintaining a record of forwarded data packets.

22. The computer readable medium of claim 21, wherein the record of forwarded data packets includes groups of forwarded data packets.

23. A data stream, comprising:
a plurality of data packets;
wherein the plurality of data packets include first data packets received from a first data stream and second data packets received from a second data stream, the first and second data streams comprising a plurality of corresponding data packets;
wherein the first data packets included in the data stream include first data packets received before corresponding second data packets; and
wherein the second data packets included in the data stream include second data packets received before corresponding first data packets.

24. The data stream of claim 23, wherein the merged data stream comprises at least a portion of an internet protocol television multicast video content stream.

25. The data stream of claim 23, wherein the first data packets and second data packets are intermixed.
